(19) United States
(12) Patent Application Publication
(10) Pub. No.: US 2011/0248038 A1
(43) Pub. Date: Oct. 13, 2011

(54) PASSIVE THERMALLY CONTROLLED BULK SHIPPING CONTAINER

(75) Inventor: William T. Mayer, Stacy, MN (US)

(73) Assignee: MINNESOTA THERMAL SCIENCE, LLC, Plymouth, MN (US)

(21) Appl. No.: 13/082,515

(22) Filed: Apr. 8, 2011

Related U.S. Application Data
(60) Provisional application No. 61/322,460, filed on Apr. 9, 2010.

(51) Int. Cl. B65D 81/38; B23P 19/04

(52) U.S. Cl. 220/592.27; 220/592.01; 220/592.2; 29/428

(57) ABSTRACT

A kit capable of being assembled into a passive thermally controlled bulk shipping container, and associated method of assembly and resultant assembled shipping container. The kit includes (a) an outer shell defining a retention chamber, (b) at least eight separate and distinct identically sized phase change material-containing panels, and (c) at least four separate and distinct identically sized jackets, each configured and arranged to releasably retain a set of the phase change material panels in a planar configuration.

This application claims the benefit of U.S. Provisional Application No. 61/322,460, filed Apr. 9, 2010.

### BACKGROUND

The bulk shipment of temperature sensitive goods is extremely difficult when the shipping container itself is not independently temperature controlled; i.e., does not have an independent power source for maintaining interior temperatures within close parameters. Of course, if it is merely desired to maintain an object to be shipped at a nominally cooled temperature a common practice is to pack a shipping container with ice, and hope that the ice will remain in a frozen state during transit so that the object shipped will arrive at its destination still cooled below ambient temperature. This can be an adequate technique for shipping objects where the temperature of the payload need not be maintained with any precision. However, even in this case, the temperatures at different points inside the shipping container can and often do vary widely, with certain areas within the payload retention chamber cooled effectively by the ice, while other areas in the payload retention chamber are warmed significantly by heat transfer into the chamber through the walls of the container.

Certain thermally labile goods, such as medical supplies, blood, and vaccines, are often extremely temperature sensitive and need to be maintained within a tight temperature range to avoid deactivation, decomposition or spoilage. Transport of such thermally labile materials is particularly challenging. Such temperature sensitive goods are shipped to a wide variety of destinations, where the ambient temperature may vary from extreme cold in the frozen tundra of Alaska, to extreme heat in the desert southwest of the United States.

Hence, a need continues to exist for a high quality, passively thermal controlled bulk shipping container.

### SUMMARY OF THE INVENTION

A first aspect of the invention is a kit capable of being assembled into a passive thermally controlled bulk shipping container. The kit includes (a) an outer shell defining a retention chamber, (b) at least eight separate and distinct identically sized phase change material-containing panels, and (c) at least four separate and distinct identically sized jackets, each configured and arranged to releasably retain a set of the phase change material panels in a planar configuration.

A second aspect of the invention is a passive thermally controlled bulk shipping container. The container includes (i) a shell defining a retention chamber, (ii) a lining of thermal insulation within the retention chamber to define a thermally insulated retention chamber, and (iii) a removable lining of phase change material within the thermally insulated retention chamber to define a thermally controlled payload retention chamber, wherein the lining of phase change material is formed from a plurality of individually repositionable jackets with each jacket releasably retaining a set of phase change material panels in a planar configuration.

A third aspect of the invention is a method of assembling a passive thermally controlled bulk shipping container. The method includes the steps of (A) obtaining a kit in accordance with the first aspect of the invention, (B) thermally conditioning the phase change material-containing panels in a thermal conditioning unit, (C) inserting the thermally conditioned phase change material-containing panels into the jackets to form packed jackets, and (D) lining the retention chamber defined by the outer shell with the packed jackets, with each jacket abutting at least two other jackets to define a thermally controlled payload retention chamber.

### BRIEF DESCRIPTION OF THE DRAWINGS

FIG. 1 is an exploded perspective view of one embodiment of the invention.

FIG. 2A is a front view of a pair of PCM panels depicted in FIG. 1 configured as if in a jacket.

FIG. 2B is a front view of one of the thermally charged jackets depicted in FIG. 1.

FIG. 2C is a top view of the jacket sans PCM panels depicted in FIG. 2A.

FIG. 2D is a side view of the jacket sans PCM panels depicted in FIG. 2A.

FIG. 2E is a bottom view of the jacket sans PCM panels depicted in FIG. 2A.

FIG. 3A is a cross-sectional side view of a partially assembled shipping container in accordance with the invention depicted in FIG. 1, with the impact protective foam and thermal insulation lining the retention chamber defined by the outer shell.

FIG. 3B is a cross-sectional side view of the partially assembled shipping container depicted in FIG. 3A with the jacketed PCM panels lining the thermally insulated retention chamber, the spacer bar and support beam placed and the cap covering the top of the container.

### DETAILED DESCRIPTION OF A PREFERRED EMBODIMENT

### Definitions

As utilized herein, including the claims, the phrase “thermal conditioning unit” means equipment capable of heating and/or cooling a phase change material within a predefined temperature range. Exemplary thermal conditioning units include freezers, refrigerators, coolers, ovens, furnaces, autoclaves, kilns, etc.

### Nomenclature

10 Passive Thermally Controlled Bulk Shipping Container
11 Base Component of Container
12 Cap Component of Container
19 Payload Retention Chamber
20 Outer Protective Shell
29 Retention Chamber
30 Impact Protective Foam Panel
40 Thermal Insulation Panel
49 Thermally Insulated Retention Chamber
50 Phase Change Material Panel (PCM Panel)
59 Dimple in PCM Panel
60 Jacket
61 Edges of Jacket
68 Opening Through Face of Jacket
69 PCM Retention Compartment
69′ Open End of PCM Retention Compartment
70 Jacket Retaining Thermally Charged PCM Panels (PCM Charged Jacket)
70a PCM Charged Jackets Forming the Sidewalls of the Payload Retention Chamber
70b PCM Charged Jackets Forming the Bottom of the Payload Retention Chamber
70c PCM Charged Jackets Forming the Ceiling of the Payload Retention Chamber
80 Spacer Bar
90 Support Beam

### Construction

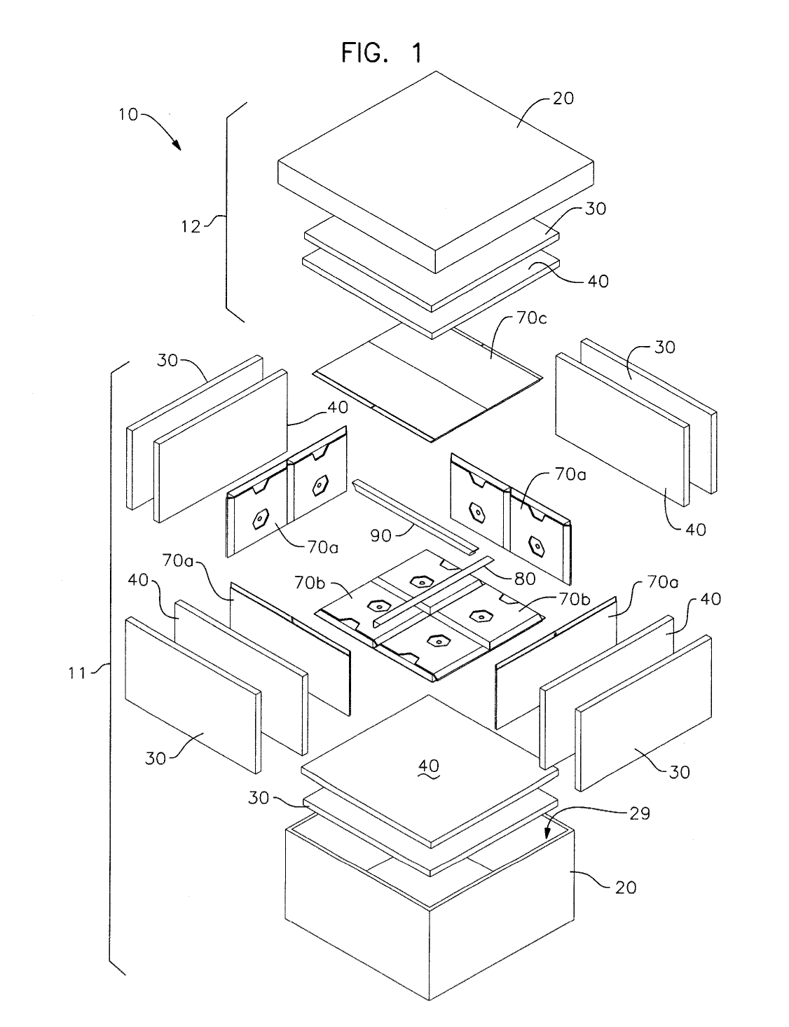

Referring generally to FIG. 1, the present invention is directed to a kit for assembling a passive thermally controlled bulk shipping container 10 and the assembled shipping container 10.

The shipping container 10 may have an outside shell 20 made from any material possessing sufficient structural integrity, such as plastic, corrugated cardboard or the like.

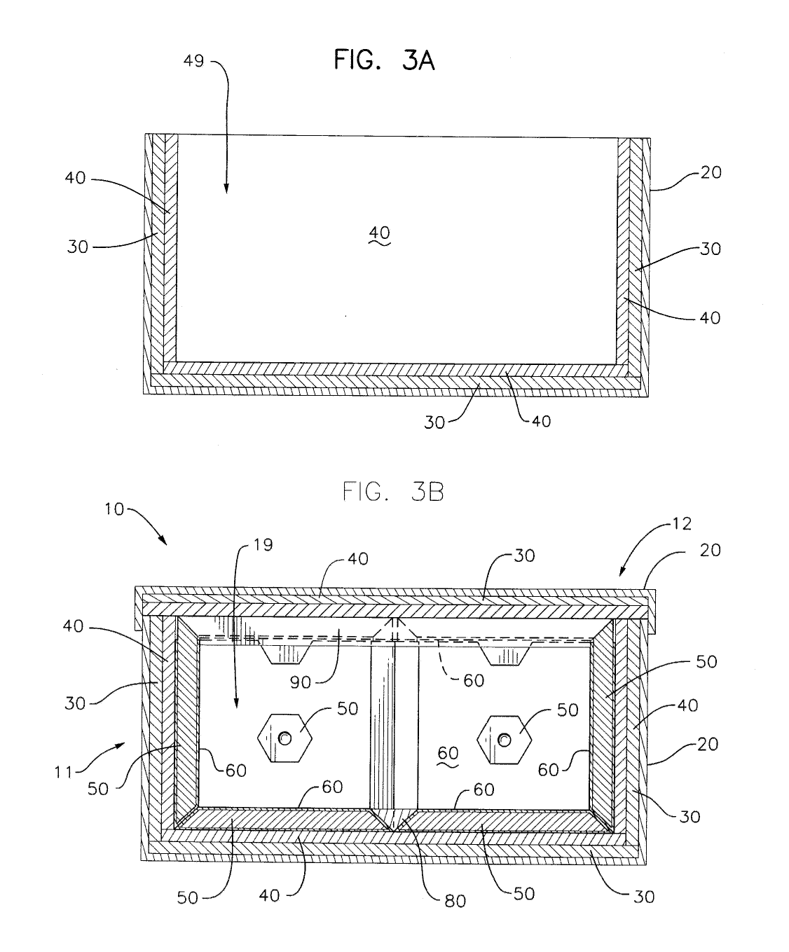

Referring to FIGS. 1 and 3A, the shipping container 10 preferably includes panels of moderately insulating high-density foam 30 inserted within the retention chamber 29 defined by the outer shell 20 and snugly against the inner surfaces of the outer shell 20, effective for enhancing the structural integrity of the container 10 and damping any impacts.

Again referring to FIGS. 1 and 3A, panels of thermal insulation 40 are provided for thermally insulating the shipping container 10. The insulation panels 40 may be vacuum insulated panels, styrofoam or the like, or any material having, good insulation qualities, i.e., having a high thermal resistance “R”.

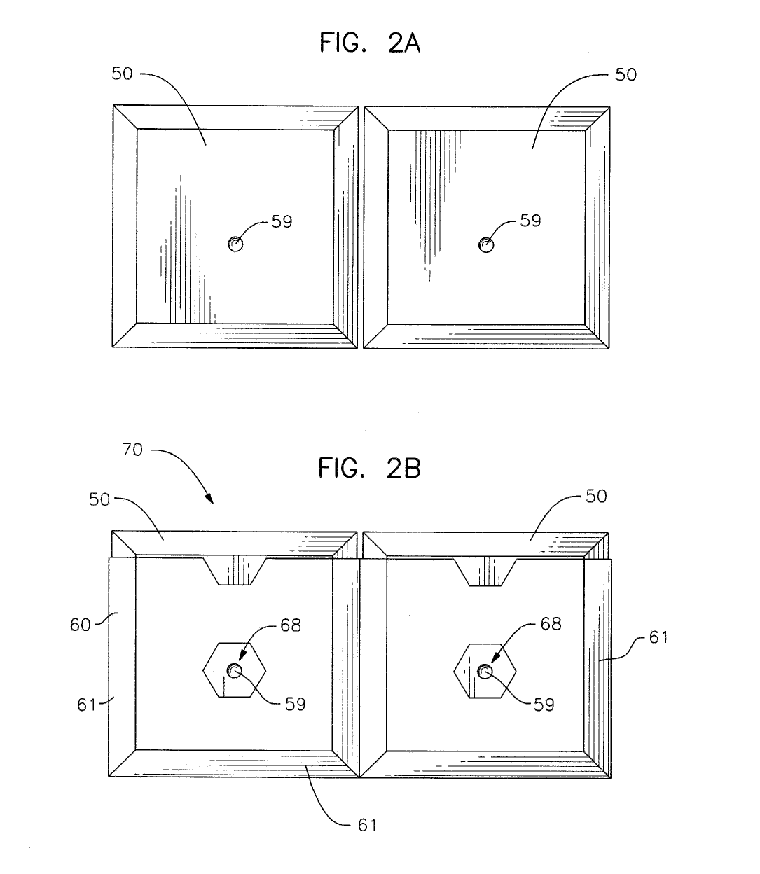

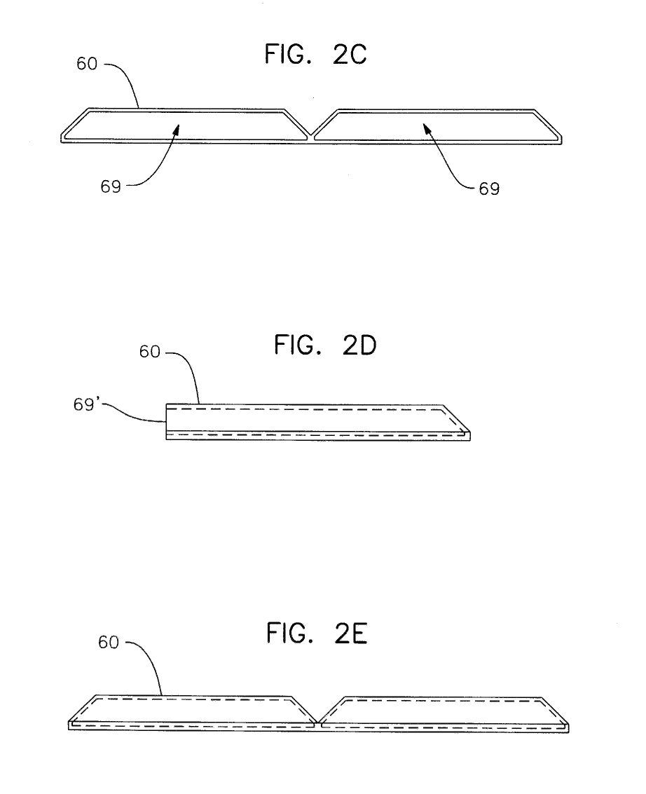

Referring to FIGS. 1 and 3B, the thermally insulated retention chamber 49 formed by the insulation panels 40 is lined with panels of phase change material (PCM panel) 50 which are locked into position within the container 10 by jackets 60. Referring to FIGS. 2A-D, the jackets 60 preferably have beveled edges 61 for facilitating the construction of a self-supporting envelope of thermally conditioned PCM panels 50 within the thermally insulated retention chamber 49 (i.e., the edges 61 of each jackets 60 are supported by the edges 61 of adjacent jackets 60 so that they cannot collapse inward). When a cuboidal shipping container 10 is desired, the jackets 60 are preferably shaped as a frustum of a rectangular pyramid with all four edges angled at 45°. Each jacket 60 includes at least two PCM retention compartments 69 with an open end 69′ into which a PCM panel 50 may be selectively inserted and removed. When the jackets 60 are configured and arranged such that an edge of the PCM panels 50 inserted into the jacket 60 extends beyond an edge of the jacket 60, as is the case for the embodiment depicted in the Figures, at least the exposed edge of the PCM panel 50 also needs to be beveled to match the bevel on the edges 61 of the jackets 60.

The PCM panels 50 are filled with a phase change material, such as water or other desired material.

The jackets 60 are preferably uniformly sized and shaped, with uniformly beveled 45° edges, thereby allowing the jackets 60 to be interchangeably fit together within the thermally insulated retention chamber 49. Such uniformity facilitates inventory and assembly as only one size jacket 60 and one size PCM panel 50 need be purchased, conditioned and installed.

The jackets 60 may be constructed from any material providing the necessary structural integrity, including specifically but not exclusively, plastics such as polyethylene, polypropylene and polyurethane; cellulosics such as cardboard and cardstock; and metals such as steel or aluminum. Plastics are generally preferred as the most cost efficient and lightest weight option.

The PCM panels 50 may be conditioned, i.e., heated or cooled in a thermal conditioning unit, by removing them from the jackets 60 or leaving them in the jacket 60 and conditioning the entire PCM charged jacket 70.

Referring to FIGS. 1 and 3B, the cap or cover 12 of the shipping container 10 is selectively removable from the base 11 of the shipping container 10 for allowing insertion and removal of goods as well as the PCM panels 50. The cover 12, as with the base 11, preferably includes an outer shell 20, foam panel 30 and insulating panel 40.

Referring to FIGS. 1 and 3B, a spacer bar 80 can be placed between the PCM charged jackets 70b covering the floor of the thermally insulated retention chamber 49 to prevent shifting of the PCM charged floor jackets 70b. The elongated side edges of the spacer bar 80 are preferably angled to match the angle of the edges on the jackets 60.

Again referring to FIGS. 1 and 3B, a support beam 90 is preferably provided across the open top of the payload retention chamber 19 to support the PCM charged ceiling jackets 70c placed over the top of the payload retention chamber 19. The ends and elongated edges of the support beam 90 are preferably angled to match the angle of the edges on the jackets 60, i.e., shaped as a frustum of a rectangular pyramid. The spacer bar 80 and the support beam 90 are preferably shaped so as to be interchangeable.

If desired, multiple tiers of end wall and sidewall assemblies (i.e., outer shell 20, foam panels 30, thermal insulation panels 40 and PCM charged jackets 70) may be stacked on top of an assembled base tier by employing appropriate bracing (not shown) to interlock the tiers.

Selectively engagable and releasable strapping (not shown) may be employed around a fully assembled and loaded container 10 as desired to “lock down” the cover (not shown).

### Assembly and Use

The container 10 can be assembled and disassembled by hand without the need for any tools. Panels of foam 30 and thermal insulation 40 are obtained and placed against the floor, end walls and sidewalls of an outer shell 20 as shown in FIGS. 1 and 3A. Thermally conditioned PCM panels 50 are retrieved from an appropriate thermal conditioning unit (not shown) and slid into the PCM retention compartments 69 of several jackets 60 through the open end 68 of the jackets 60 to form PCM charged jackets 70 as shown in FIGS. 1 and 2A.

A pair of PCM charged jackets 70 are placed over the floor of the thermally insulated retention chamber 49 and a spacer bar 80 positioned between the PCM charged floor jackets 70b (FIGS. 1A and 3B). PCM charged jackets 70 are then placed against the end walls and sidewalls of the thermally insulated retention chamber 49 with the beveled edges of the PCM charged sidewall jackets 70a and the PCM charged floor jackets 70b abutting one another along the corners so as to form a self-supporting base assembly (FIG. 3B).

A support beam 90 may need to be placed across the open top of the thermally insulated retention chamber 49 with the ends of the support beam 90 engaging the upper edges of the PCM charged sidewall jackets 70a (FIG. 1E). A pair of PCM charged jackets 70 may then be dropped into position over the open top of the thermally insulated retention chamber 49 with the beveled edges of the PCM charged ceiling jackets 70c abutting the beveled edges of the PCM charged wall jackets 70a and the support beam 90 so as to form a self-supporting fully enclosed base assembly (FIG. 3B).

A thermally labile payload (not shown) can be deposited into the payload retention chamber 19 through the open top once the PCM charged sidewall jackets 70a have been positioned within the thermally insulated retention chamber 49.

The cap 12 can then be placed over the PCM charged ceiling jackets 70c, and the fully assembled container 10 secured, such as by tie down straps (not shown) and associated tie down hardware (not shown) exemplified by cam-type fasteners permanently attached to the top of the cap.

Upon delivery of the thermally labile payload (not shown) the empty container 10 can be disassembled with the spent PCM panels 50, either removed from or retained within the associated jacket 60 and placed in an appropriate thermal conditioning unit (not shown) for thermal reconditioning.

An opening 68 is provided through an upper face of each jacket 60 into each PCM retention compartment 69 in the jacket 60 to facilitate removal of spent PCM panels 50 from the PCM retention compartments 69 by allowing an individual to insert a finger into an exposed dimple 59 on the face of each PCM panel 50 and using the inserted digit to initiate sliding of the PCM panel 50 out through the open end 69′ of the PCM retention compartment 69.

We claim:

1. A kit capable of assembly into a passive thermally controlled bulk shipping container, the kit including at least:
(a) an outer shell defining a retention chamber,
(b) at least eight separate and distinct identically sized phase change material-containing panels, and
(c) at least four separate and distinct identically sized jackets, each configured and arranged to releasably retain a set of the phase change material panels in a planar configuration.

2. The kit of claim 1 wherein the jackets are sized, configured and arranged to form a lining within the retention chamber defined by the outer shell to define a payload retention chamber.

3. The kit of claim 1 further comprising at least four panels of thermal insulation.

4. The kit of claim 3 wherein the panels of thermal insulation are sized, configured and arranged to form a lining within the retention chamber defined by the outer shell to define a thermally insulated retention chamber, and the jackets are sized, configured and arranged to form a lining within the thermally insulated retention chamber to define a thermally controlled payload retention chamber.

5. The kit of claim 1 further comprising at least six panels of identically sized thermal insulation.

6. The kit of claim 5 wherein the panels of thermal insulation are vacuum insulated panels.

7. The kit of claim 1 wherein the kit includes at least twelve of the phase change material-containing panels and at least six of the jackets.

8. The kit of claim 1 wherein the kit includes at least sixteen of the phase change material-containing panels and at least eight of the jackets.

9. The kit of claim 1 wherein the jackets each retain a pair of phase change material panels in a side-to-side configuration.

10. The kit of claim 1 wherein the jackets have beveled edges.

11. The kit of claim 10 wherein the beveled edges on the jackets are beveled at a 45° angle.

12. A passive thermally controlled bulk shipping container comprising:
(a) a shell defining a retention chamber,
(b) a lining of thermal insulation within the retention chamber to define a thermally insulated retention chamber, and
(c) a removable lining of phase change material within the thermally insulated retention chamber to define a thermally controlled payload retention chamber, wherein the lining of phase change material is formed from a plurality of individually repositionable jackets with each jacket releasably retaining a set of phase change material panels in a planar configuration.

13. The bulk shipping container of claim 12 wherein the lining of thermal insulation is formed from at least four panels of thermal insulation.

14. The bulk shipping container of claim 12 wherein the lining of thermal insulation is formed from at least six panels of identically sized thermal insulation.

15. The bulk shipping container of claim 13 wherein the panels of thermal insulation are vacuum insulated panels.

16. The bulk shipping container of claim 12 wherein the lining of phase change material includes at least twelve of the phase change material-containing panels and at least six of the jackets.

17. The bulk shipping container of claim 12 wherein the jackets have beveled edges.

18. The bulk shipping container of claim 17 wherein the beveled edges on the jackets are beveled at a 45° angle.

19. The bulk shipping container of claim 12 wherein the lining of phase change material is formed from tessellated jackets.

20. The bulk shipping container of claim 12 wherein the jackets each retain a pair of phase change material panels in a side-to-side configuration.

21. The bulk shipping container of claim 12 wherein the phase change material is water.

22. A method of assembling a passive thermally controlled bulk shipping container, comprising the steps of:
(a) obtaining the kit of claim 1,
(b) thermally conditioning the phase change material-containing panels in a thermal conditioning unit,
(c) inserting the thermally conditioned phase change material-containing panels into the jackets to form packed jackets, and
(d) lining the retention chamber defined by the outer shell with the packed jackets, with each jacket abutting at least two other jackets to define a thermally controlled payload retention chamber.

23. The method of claim 22, further comprising the steps of:
(a) obtaining a plurality of thermal insulating panels, and
(b) prior to lining the retention chamber defined by the outer shell with the packed jackets, lining the retention chamber with the thermal insulating panels with each thermal insulating panel abutting at least two other thermal insulating panels to define a thermally insulated retention chamber,
(c) wherein the packed jackets line the thermally insulated retention chamber.

24. The method of claim 23 wherein the retention chamber is lined with at least six identically sized panels of thermal insulation.

25. The method of claim 24 wherein the thermally controlled payload retention chamber is lined with at least six identically sized packed jackets with each jacket packed with at least two thermally conditioned phase change material-containing panels.

26. The method of claim 23 wherein the jackets have beveled edges.

27. The method of claim 26 wherein the beveled edges on the jackets are beveled at a 45° angle.
